(19) United States
(12) Patent Application Publication
(10) Pub. No.: US 2025/0132329 A1
(43) Pub. Date: Apr. 24, 2025

(54) Secondary Battery and Battery Assembly

(71) Applicant: SK On Co., Ltd., Seoul (KR)

(72) Inventors: Jun Hee HAN, Daejeon (KR); Sung Soon PARK, Daejeon (KR); Seong Cho KWON, Daejeon (KR); Moon Sung KIM, Daejeon (KR); Hyo Mi KIM, Daejeon (KR); Sang Baek RYU, Daejeon (KR); Da Hye PARK, Daejeon (KR); Sang Won PARK, Daejeon (KR); Sang In BANG, Daejeon (KR); Seung Hyun YOOK, Daejeon (KR); Hwan Ho JANG, Daejeon (KR); Da Bin CHUNG, Daejeon (KR)

(21) Appl. No.: 18/914,422

(22) Filed: Oct. 14, 2024

(30) Foreign Application Priority Data
Oct. 19, 2023 (KR) 10-2023-0140397

(51) Int. Cl. H01M 4/525; H01M 4/02; H01M 4/131; H01M 4/36; H01M 4/62; H01M 50/54

(52) U.S. Cl. CPC H01M 4/525; H01M 4/131; H01M 4/366; H01M 4/621; H01M 50/54; H01M 2004/021; H01M 2004/028

(57) ABSTRACT

A secondary battery includes a first cathode group in which first cathodes are stacked adjacent to each other, a second cathode group in which second cathodes are stacked adjacent to each other, and anodes facing the first cathode or the second cathode. Each of the first cathodes includes a first cathode current collector and a first cathode active material layer on the first cathode current collector. Each of the second cathodes includes a second cathode current collector and a second cathode active material layer on the second cathode current collector. The second cathode active material layer has a different active material composition or a different stacked structure from that of the first cathode active material layer.

### CROSS-REFERENCE TO RELATED APPLICATION AND CLAIM OF PRIORITY

This application claims priority to Korean Patent Application No. 10-2023-0140397 filed on Oct. 19, 2023 in the Korean Intellectual Property Office (KIPO), the entire disclosure of which is incorporated by reference herein.

### TECHNICAL FIELD

The disclosure of this patent application relates to a secondary battery and a battery assembly including the same. More particularly, the disclosure of this patent application relates to a secondary battery including a plurality of cathode structures and a battery assembly including the same.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of eco-friendly vehicles such as an electric automobile.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

An NCM-based active material containing nickel, cobalt and manganese is used as a cathode active material of the lithium secondary battery. As an application range of the lithium secondary battery is extended to a large-scaled device such as an electric vehicle, a high-Ni-based lithium oxide having a high nickel content is developed as the cathode active material for providing high capacity of the lithium secondary battery.

However, as the content of nickel in the cathode active material increases, chemical structure and stability of a crystal structure in an active material particle may be deteriorated. For example, a large amount of gas may be generated due to side reactions in a high SOC (state of charge) during repeated charging and discharging.

Further, as the nickel content increases, capacity properties may be increased, but rate properties such as a rapid charging performance may be decreased.

### SUMMARY

According to an aspect of the present disclosure, there is provided a secondary battery having improved stability and charge/discharge properties.

According to an aspect of the present disclosure, there is provided a battery assembly having improved stability and charge/discharge properties.

A secondary battery includes a first cathode group in which first cathodes are stacked adjacent to each other, a second cathode group in which second cathodes are stacked adjacent to each other, and anodes facing the first cathode or the second cathode. Each of the first cathodes includes a first cathode current collector and a first cathode active material layer on the first cathode current collector. Each of the second cathodes includes a second cathode current collector and a second cathode active material layer on the second cathode current collector.

In some embodiments, the first cathode active material layer may include a first lithium-nickel-based metal oxide, and the second cathode active material layer may include a second lithium-nickel-based metal oxide having a nickel molar ratio smaller than that of the first lithium-nickel-based metal oxide.

In some embodiments, a mole fraction of nickel among elements excluding lithium and oxygen in the first lithium-nickel-based metal oxide may be 0.9 or more.

In some embodiments, a mole fraction of nickel among elements excluding lithium and oxygen in the second lithium-nickel-based metal oxide may be 0.8 or more, and less than 0.9.

In some embodiments, the second lithium-nickel-based metal oxide may include large-diameter particles and small-diameter particles having different average particle sizes.

In some embodiments, the large-diameter particles may have a secondary particle shape, and the small-diameter particles may have a single particle shape.

In some embodiments, the first cathode active material layer may have a single-layered structure, and the second cathode active material layer may have a multi-layered structure.

In some embodiments, the second cathode active material layer may include a lower cathode active material layer and an upper cathode active material layer sequentially stacked from a surface of the second cathode current collector. Each of the upper cathode active material layer and the lower cathode active material layer may include a second lithium-nickel-based metal oxide and a binder. The upper cathode active material layer and the lower cathode active material layer may have different binder contents.

In some embodiments, a binder content based on weight percents contained in the upper cathode active material layer may be smaller than a binder content based on weight percents contained in the lower cathode active material layer.

In some embodiments, the first cathode current collector may include a first cathode tab portion, and the second cathode current collector may include a second cathode tab portion horizontally spaced apart from the first cathode tab portion.

In some embodiments, the secondary battery may further include a cathode lead fused together with the first cathode tab portion and the second cathode tab portion.

In some embodiments, the secondary battery may further include a first cathode lead fused with the first cathode tab portion, and a second cathode lead fused with the second cathode tab portion and separated from the first cathode lead.

In some embodiments, the first cathode group, the second cathode group and the anodes are stacked to define an electrode assembly. The first cathode group may be arranged at an upper layer portion of the electrode assembly, and the second cathode group may be arranged at a lower layer portion of the electrode assembly.

A battery assembly includes a plurality of battery cells each of which includes the above-described secondary battery.

In some embodiments, the battery assembly may further include a first cathode module terminal connected to the first cathode current collector included in the first cathode group, and a second cathode module terminal connected to the second cathode current collector included in the second cathode group. The first cathode module terminal and the second cathode module terminal may be independently separated.

The secondary battery according to the above-described embodiments may include a first cathode and a second cathode having different compositions and stacked structures. A high-capacity characteristic may be more effectively implemented from the first cathode, and high-rate and rapid charge properties may be more effectively improved from the second cathode.

The first cathodes may be assembled to form a first cathode group, and the second cathodes may be assembled to form a second cathode group. In some embodiments, depending on the application target of the secondary battery or a battery module, the first cathode group and the second cathode group may be operated independently. Thus, different current/capacity properties may be implemented from one battery or module.

### BRIEF DESCRIPTION OF THE DRAWINGS

FIGS. 1 and 2 are schematic cross-sectional views illustrating cathodes included in a secondary battery in accordance with example embodiments.

FIG. 3 is a schematic cross-sectional view illustrating an anode included in a secondary battery in accordance with example embodiments.

FIG. 4 is a schematic plan view illustrating a secondary battery in accordance with example embodiments.

FIGS. 5 and 6 are schematic cross-sectional views illustrating a secondary battery in accordance with example embodiments.

FIG. 7 is a schematic plan view illustrating a secondary battery in accordance with example embodiments.

FIGS. 8 and 9 are s schematic cross-sectional view and a schematic plan view, respectively, for describing a battery assembly in accordance with example embodiments.

### DETAILED DESCRIPTION OF THE EMBODIMENTS

According to embodiments disclosed in the present application, a secondary battery including different types of cathodes is provided. Further, a battery assembly including the secondary battery is also provided.

The secondary battery according to the present disclosure may be widely applied in green technology fields such as an electric vehicle, a battery charging station, a solar power generation, a wind power generation, etc., using a battery, etc. The secondary battery according to the present disclosure may be used for eco-friendly electric vehicles and hybrid vehicles to prevent a climate change by suppressing air pollution and greenhouse gas emissions. etc.

Hereinafter, the present disclosure will be described in detail with reference to the attached drawings and example embodiments. However, those are merely provided as examples and the present disclosure is not limited to the specific embodiments disclosed herein.

The terms “upper”, “upper layer”, “lower layer”, “lower layer”, etc., used herein do not designate absolute positions, but are intended to indicate relative positions or locations. For example, the terms are used relatively to designate different regions with respect to a specific reference plane.

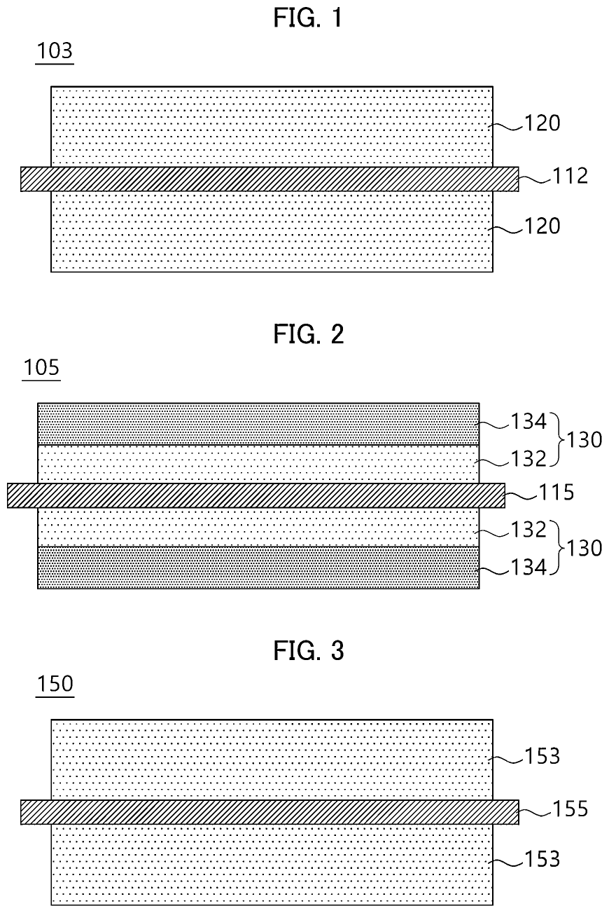

FIGS. 1 and 2 are schematic cross-sectional views illustrating cathodes included in a secondary battery in accordance with example embodiments.

Referring to FIGS. 1 and 2, a secondary battery may include a first cathode 103 and a second cathode 105.

The first cathode 103 may include a first cathode current collector 112 and a first cathode active material layer 120 formed on a surface of the first cathode current collector 112.

The first cathode current collector 112 may include, e.g., stainless steel, nickel, aluminum, titanium, copper, or an alloy thereof. In an embodiment, the first cathode current collector 112 may include aluminum or an aluminum alloy.

The first cathode active material layer 120 may be formed on an upper surface or a lower surface of the first cathode current collector 112. In an embodiment, the first cathode active material layer 120 may be formed on the upper surface and the lower surface of the first cathode current collector 112, and the first cathode 103 may have a double-sided coating structure.

The first cathode active material layer 120 may include a first cathode active material, and a first lithium-nickel-based metal oxide may be used as the first cathode active material. The secondary battery may be a lithium secondary battery using a lithium-nickel-based cathode active material.

In example embodiments, a mole fraction of nickel among metals other than lithium and oxygen included in the first lithium-nickel-based metal oxide may be 0.8 or more.

In some embodiments, the mole fraction of nickel in the first lithium-nickel-based metal oxide may be 0.85 or more. In an embodiment, the mole fraction of nickel in the first lithium-nickel-based metal oxide may be 0.88 or more, 0.9 or more, or 0.92 or more.

In some embodiments, the mole fraction of nickel in the first lithium-nickel-based metal oxide may be 0.98 or less. For example, the mole fraction of nickel in the first lithium-nickel-based metal oxide may be in a range from 0.8 to 0.98, from 0.85 to 0.98, from 0.88 to 0.98, 0.9 to 0.98, or from 0.92 to 0.98.

The first lithium-nickel-based metal oxide may further include at least one of cobalt (Co) and manganese (Mn). In some embodiments, the first lithium-nickel-based metal oxide may further include cobalt and manganese, and may be provided as a Ni—Co—Mn (NCM)-based lithium oxide.

Ni may serve as a transition metal related to a power and a capacity of the lithium secondary battery. Thus, a high-content (High-Ni) composition as described above may be employed in the cathode active material, so that a high-capacity cathode and a high-capacity lithium secondary battery may be implemented.

However, as the content of Ni increases, long-term storage stability and life-span stability of the cathode or the secondary battery may be relatively degraded. However, according to example embodiments, Co may be included so that electrical conductivity may be maintained while improving life-span stability and capacity retention properties by including Mn.

The first lithium-nickel-based metal oxide may include a layered structure or crystal structure represented by Chemical Formula 1.

LiₓNiₐM_{b}O_{2+z} [Chemical Formula 1]

In Chemical Formula 1, 0.9≤x≤1.2, 0.8≤a≤0.98, 0.02≤b≤0.2, and −0.5≤z≤0.1. As described above, M may include Co, Mn and/or Al.

The chemical structure represented by Chemical Formula 1 represents a bonding relationship included in the layered structure or the crystal structure of the cathode active material, and does not exclude other additional elements. For example, M includes Co and/or Mn, and Co and/or Mn may serve as a main active element of the cathode active material together with Ni. Chemical Formula 1 is provided to express the bonding relationship of the main active element and is to be understood as a formula encompassing introduction and substitution of the additional elements.

In an embodiment, an auxiliary element for enhancing chemical stability of the cathode active material or the layered structure/crystal structure in addition to the main active element may be further included. The auxiliary element may be incorporated into the layered structure/crystal structure to form a bond, and this case is to be understood as being included within the range of the chemical structure represented by Chemical Formula 1.

The auxiliary element may include at least one of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al that contributes to capacity/power activity of the cathode active material together with Co or Mn.

For example, the first lithium-nickel-based metal oxide may include a layered structure or a crystal structure represented by Chemical Formula 1-1.

LiₓNiₐM1_{b1}M2_{b2}O_{2+z} [Chemical Formula 1-1]

In Chemical Formula 1-1, M1 may include Co and/or Mn. M2 may include the above-described auxiliary element. In Chemical Formula 1-1, 0.9≤x≤1.2, 0.8≤a≤0.98, 0.02≤b1+b2≤0.2, and −0.5≤z≤0.1.

An amount of the first lithium-nickel-based metal oxide may be 50 weight percent (wt %) or more based on a total weight of the first cathode active material. In example embodiments, the amount of the first lithium-nickel-based metal oxide may be 60 wt % or more, 70 wt % or more, 80 wt % or more, or 90 wt % or more based on the total weight of the first cathode active material.

In an embodiment, the first cathode active material may substantially consist of the first lithium-nickel-based metal oxide.

In example embodiments, the first lithium-nickel-based metal oxide particles may be prepared by reacting a nickel-containing precursor and a lithium precursor. The nickel-containing precursor may further include, e.g., manganese and/or cobalt.

In some embodiments, the nickel-containing precursor may be prepared in the form of a Ni—Co—Mn precursor (e.g., (NCM)-hydroxide). For example, the nickel-containing precursor may be prepared by reacting a nickel source, a cobalt source and a manganese source through a co-precipitation method. The nickel source, cobalt source and manganese source may include hydroxide, sulfate, carbonate, acetate, nitrate, etc., of nickel, cobalt and manganese, respectively.

The nickel-containing precursor and the lithium precursor (e.g., lithium hydroxide or lithium carbonate) may be reacted, e.g., through a co-precipitation method to produce the first lithium-nickel-based metal oxide.

A precipitating agent and/or a chelating agent may be used to promote the co-precipitation reaction. The precipitating agent may include an alkaline compound such as sodium hydroxide (NaOH), sodium carbonate (Na₂CO₃), etc. The chelating agent may include, e.g., ammonia water, ammonium carbonate, etc.

In some embodiments, in addition to nickel, cobalt and manganese, a doping element source selected from the above-described auxiliary element may be reacted together. Accordingly, the first lithium-nickel-based metal oxide may include a doping incorporated into an internal crystal structure/layered structure.

In example embodiments, two or more of the auxiliary elements may be included as the doping. The first lithium-nickel-based metal oxide may have relatively enhanced high high-temperature stability, and may suppress gas generation due to side reactions with the electrolyte even when charge/discharge is repeated at high temperature to provide improved capacity retention.

Further, the first lithium-nickel-based metal oxide may have a relatively increased Ni content to provide high-capacity properties.

In some embodiments, a calcination process may be further performed after preparing the first lithium-nickel-based metal oxide particle. For example, the calcination process may be performed at a temperature from about 600° C. to 1000° C. The layered structure of the first lithium-nickel-based metal oxide particle may be stabilized by the calcination process, and the doping element may be fixed.

In some embodiments, a water (pure water) washing process for the first lithium-nickel-based metal oxide may be omitted. Accordingly, a surface damage and an oxidation of the first lithium-nickel-based metal oxide caused during the washing process may be prevented. Accordingly, high-temperature stability of the first lithium-nickel-based metal oxide may be further improved.

For example, the above-described first cathode active material may be mixed and stirred with a binder, a conductive material and/or a dispersant in a solvent to prepare a slurry. The slurry may be coated on the cathode current collector 112, and then dried and pressed to prepare the first cathode 103.

The binder may include, e.g., an organic binder such as vinylidene fluoride-hexafluoropropylene copolymer (PVDF-co-HFP), polyvinylidene fluoride (PVDF), polyacrylonitrile, polymethylmethacrylate, or an aqueous binder such as styrene-butadiene rubber (SBR) that may be used together with a thickener such as carboxymethyl cellulose (CMC).

For example, a PVDF-based binder may be used as the binder for forming the cathode. In this case, an amount of the binder for forming the cathode active material layer 120 may be reduced, and an amount of the cathode active material may be relatively increased, thereby improving the power and capacity of the secondary battery.

The conductive material may be included to promote an electron transfer between active material particles. For example, the conductive material may include a carbon-based conductive material such as graphite, carbon black, graphene, carbon nanotube, etc., and/or a metal-based conductive material including such as tin, tin oxide, titanium oxide, a perovskite material such as LaSrCoO₃ and LaSrMnO₃, etc.

In example embodiments, the first cathode active material layer 120 included in the first cathode 103 may have a single-layered structure. The term “single-layered structure” used herein refers to a structure in which a single active material layer is formed based on one surface of the current collector. As described above, the first lithium-nickel-based metal oxide having the increased nickel content may be employed, and the first cathode 103 including the first cathode active material layer 120 of the single-layered structure may be used to effectively implement the high-capacity properties.

Additionally, as described above, the first lithium-nickel-based metal oxide that may not be treated by a water washing may be used, so that the surface stability and high-temperature stability of the active material particles may be enhanced.

The second cathode 105 may include a second cathode current collector 115 and a second cathode active material layer 130 formed on a surface of the second cathode current collector 115.

The second cathode current collector 115 may include substantially the same metal or alloy as that of the first cathode current collector 112.

The second cathode active material layer 130 may be formed on an upper or a lower surface of the second cathode current collector 115. In an embodiment, the second cathode active material layer 130 may be formed on the upper and lower surfaces of the second cathode current collector 115, and the second cathode 105 may have a double-sided coating structure.

According to embodiments of the present disclosure, the second cathode active material layer 130 may include a cathode active material having a different composition from that of the first cathode active material layer 120, or may have a different stacked structure from that of the first cathode active material layer 120.

The second cathode active material layer 130 may include a second cathode active material, and a second lithium-nickel-based metal oxide may be used as the second cathode active material. In example embodiments, a mole fraction of nickel among metals excluding lithium and oxygen included in the second lithium-nickel-based metal oxide may be smaller than the mole fraction of nickel in the first lithium-nickel-based metal oxide.

In example embodiments, the mole fraction of nickel among the metals excluding lithium and oxygen included in the first lithium-nickel-based metal oxide may be 0.8 or more.

In some embodiments, the mole fraction of nickel in the second lithium-nickel-based metal oxide may be 0.80 or more and less than 0.90. In an embodiment, the mole fraction of nickel in the second lithium-nickel-based metal oxide may be 0.85 or more and less than 0.90.

The second lithium-nickel-based metal oxide may further include at least one of cobalt (Co) and manganese (Mn). In some embodiments, the second lithium-nickel-based metal oxide may further include cobalt and manganese, and may be provided as a Ni—Co—Mn (NCM)-based lithium oxide. The second lithium-nickel-based metal oxide may include a layered structure or a crystal structure represented by Chemical Formula 2.

LiₓNiₐL_{b}O_{2+z} [Chemical Formula 2]

In Chemical Formula 2, 0.9≤x≤1.2, 0.8≤a≤0.9, 0.1≤b≤0.2, and −0.5≤z≤0.1 As described above, L may include Co and/or Mn.

The second lithium-nickel-based metal oxide further includes the auxiliary element described above, and the auxiliary element may be provided as a surface coating.

For example, the second lithium-nickel-based metal composite oxide may include a layered structure or a crystal structure represented by Chemical Formula 2-1.

LiₓNiₐL1_{b1}L2_{b2}O_{2+z} [Chemical Formula 2-1]

In Chemical Formula 2-1, L1 may include Co and/or Mn. L2 may include the auxiliary element described above. In Chemical Formula 2-1, 0.9≤x≤1.2, 0.8≤a≤0.9, 0.1≤b1+b2≤0.2, and −0.5≤z≤0.1.

An amount of the second lithium-nickel-based metal may be 50 wt % or more oxide based on a total weight of the second cathode active material. In example embodiments, the amount of the second lithium-nickel-based metal oxide may be 60 wt % or more, 70 wt % or more, 80 wt % or more, or 90 wt % or more based on the total weight of the second cathode active material

In an embodiment, the second cathode active material may substantially consist of the second lithium-nickel-based metal oxide.

The second lithium-nickel-based metal oxide may be prepared through a reaction of the nickel-containing precursor and the lithium precursor as described above. In example embodiments, after the reaction, the surface coating including the above-described auxiliary element may be formed.

For example, a preliminary lithium-nickel-based metal oxide may be formed through a reaction of a nickel-containing precursor and a lithium precursor. The preliminary lithium-nickel-based metal oxide may be mixed and reacted with an auxiliary element source to form the surface coating. The auxiliary element source may include an oxide of the auxiliary element such as titanium oxide, zirconium oxide, aluminum oxide, etc.

In some embodiments, the second lithium-nickel-based metal oxide may have a bi-modal particle size distribution including large-diameter particles and small-diameter particles. The large-diameter particles may have a secondary particle form in which a plurality of primary particles are aggregated. The small-diameter particles may have a single particle form, and may not have the secondary particle form.

In an embodiment, an average particle diameter (D50) based on a volume cumulative distribution of the large-diameter particles may be in a range from 10 m to m, and an average particle diameter (D50) based on a volume cumulative distribution of the small-diameter particles may be in a range from 1 m to 9 km.

The second lithium-nickel-based metal oxide having the bi-modal distribution may be employed to increase a cathode density and an energy density in the second cathode active material layer 130, and rate properties and rapid charge properties may be improved by the second cathode 105. Additionally, the second lithium-nickel-based metal oxide may have a relatively lower nickel content than that of the first lithium-nickel-based metal oxide, and contents of other active elements such as cobalt may be relatively increased. Accordingly, power properties may be increased together with the rate properties from the second lithium-nickel-based metal oxide.

In example embodiments, the second cathode active material layer 130 may have a multi-layered structure based on one surface of the second cathode current collector 115. The second cathode active material layer 130 may include a lower cathode active material layer 132 and an upper cathode active material layer 134 sequentially stacked from the surface of the second cathode current collector 115.

The lower cathode active material layer 132 may be in a direct contact with the surface of the second cathode current collector 115. The upper cathode active material layer 134 may be in a direct contact with a surface of the lower cathode active material layer 132.

In example embodiments, a lower slurry and an upper slurry including the second lithium-nickel-based metal oxide and the above-described binder may be prepared. The lower slurry and the upper slurry may further include the conductive material and/or the dispersive agent as described above.

The lower slurry and the upper slurry may be sequentially coated on the second cathode current collector 115, and then dried and pressed to form the second cathode active material layer 130 including the lower cathode active material layer 132 and the upper cathode active material layer 134.

A content of the binder included in the lower cathode active material layer 132 (a binder content based on a total weight of the lower cathode active material layer 132) may be greater than a content of the binder included in the upper cathode active material layer 134 (a binder content based on a total weight of the upper cathode active material layer 134).

An amount of the binder in the lower cathode active material layer 132 may be relatively increased to enhance an adhesion to the second cathode current collector 115. In the upper cathode active material layer 134, an amount of the binder may be relatively decreased and the amount of the second lithium-nickel-based metal oxide may be increased. Accordingly, high-rate/rapid-charge/high-power properties may be stably implemented from a surface of the second cathode 105.

In some embodiments, the binder content based on the total weight of the upper cathode active material layer 134 may be less than 1 wt %, and the binder content based on the total weight of the lower cathode active material layer 132 may be in a range from 1 wt % to 2 wt %. In an embodiment, the binder content based on the total weight of the upper cathode active material layer 134 may be in a range from 0.3 wt % to 0.9 wt %, and the binder content based on the total weight of the lower cathode active material layer 132 may be in a range from 1 wt % to 1.5 wt %.

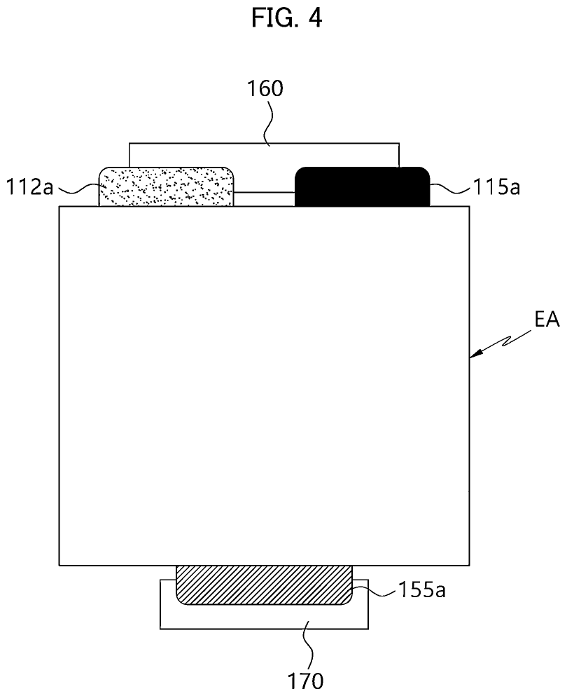

FIG. 3 is a schematic cross-sectional view illustrating an anode included in a secondary battery in accordance with example embodiments.

Referring to FIG. 3, an anode 150 may include an anode current collector 155 and an anode active material layer 153.

The anode current collector 155 may include the metal or the alloy mentioned in the cathode current collector. In some embodiments, the anode current collector 155 may include copper or a copper alloy. The anode active material layer 153 may be formed on an upper surface and/or a lower surface of the anode current collector 155. The anode active material layer 153 may be formed on each of the upper surface and the lower surface.

The anode active material layer 153 may include an anode active material and an anode binder.

The anode active material may include a carbon-based material such as a crystalline carbon, an amorphous carbon, a carbon composite or a carbon fiber; a lithium alloy; a silicon (Si)-based compound or tin, etc.

Examples of the amorphous carbon include hard carbon, coke, mesocarbon microbead (MCMB), mesophase pitch-based carbon fibers (MPCF), etc.

Examples of the crystalline carbon include a graphite-based carbon such as natural graphite, artificial graphite, graphitized coke, graphitized MCMB, graphitized MPCF, etc.

Elements included in the lithium alloy include aluminum, zinc, bismuth, cadmium, antimony, silicon, lead, tin, gallium, indium, etc.

The silicon-based compound may include, e.g., silicon (Si), silicon oxide (e.g., SiOx, 0≤x≤2) and/or a silicon-carbon composite compound containing silicon carbide (SiC).

For example, the anode active material may be mixed and stirred in a solvent with a binder, a conductive material, a thickener, etc., to prepare an anode slurry. The anode slurry may be coated on at least one surface of the anode current collector 155, and then dried and pressed to prepare the anode 150.

Materials substantially the same as or similar to those included in the cathode active material layer 120 and 130 may also be used as the bonder and the conductive material. In some embodiments, the anode binder may include, e.g., an aqueous binder such as styrene-butadiene rubber (SBR) for compatibility with the carbon-based active material which may be used together with the thickener such as carboxymethyl cellulose (CMC).

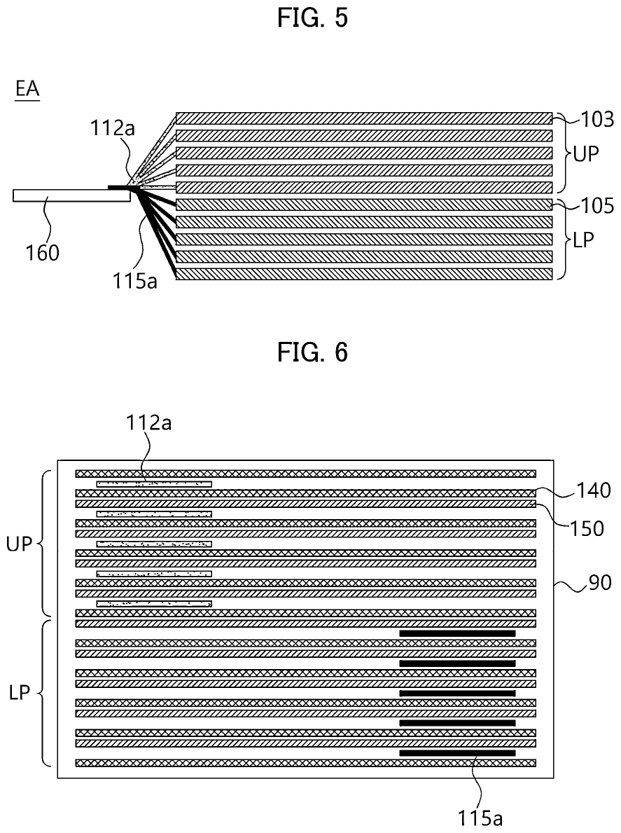

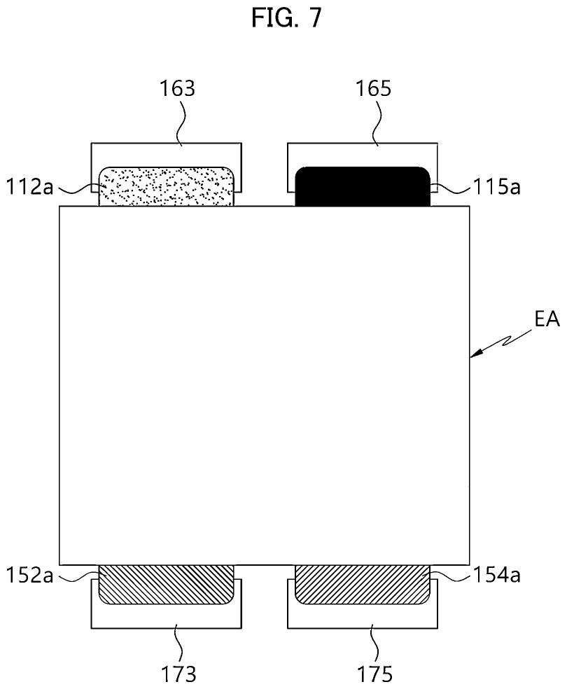

FIG. 4 is a schematic plan view illustrating a secondary battery in accordance with example embodiments. FIGS. 5 and 6 are schematic cross-sectional views illustrating a secondary battery in accordance with example embodiments. For convenience of descriptions, illustration of a case 90 is omitted in FIG. 4, and illustration of the case 90 and a separator 140 is omitted in FIG. 5. In FIG. 6, cathode tab portions 112a and 115a are only illustrated from components of a cathode.

Referring to FIGS. 4 to 6, a secondary battery may include an electrode assembly EA accommodated in the case 90.

The case 90 may include an outer material such as a pouch-type material, a can-type material, a prismatic type material, etc. In an embodiment, the case 90 may be formed as the pouch-type outer material, and the electrode assembly EA may be fabricated as a jelly-roll type.

The electrode assembly EA may include cathodes 103 and 105 and an anode 150. The electrode assembly EA may further include the separator 140 inserted between the cathode 103 and 105 and the anode 150.

A plurality of the cathodes 103 and 105 and the anodes 150 may be alternately and repeatedly stacked with the separator 140 interposed therebetween to form the electrode assembly EA. For convenience of illustration, FIG. 6 illustrates the separator 140 is separated at each level, but the separator 140 may be wound in a Z-folded shape.

The separator 140 may include a porous polymer film formed from a polyolefin polymer such as an ethylene homopolymer, a propylene homopolymer, an ethylene/butene copolymer, an ethylene/hexene copolymer, an ethylene/methacrylate copolymer, etc. The separator 140 may also include a non-woven fabric formed from a glass fiber with a high melting point, a polyethylene terephthalate fiber, etc.

According to embodiments of the present disclosure, the electrode assembly EA may include the first cathodes 103 and the second cathodes 105. In example embodiments, the electrode assembly EA may include an upper layer portion UP and a lower layer portion LP. The upper layer portion UP may include the first cathodes 103 and the anodes 150, and the lower layer portion LP may include the second cathodes 105 and the anodes 150.

In some embodiments, the cathodes of the upper layer portion UP may substantially consist of the first cathodes 103, and the cathodes of the lower layer portion LP may substantially consist of the second cathodes 105. Accordingly, a first cathode group in which a plurality of the first cathodes 103 are assembled adjacent to each other may be defined, and a second cathode group in which a plurality of the second cathodes 105 are assembled adjacent to each other may be defined.

In some embodiments, the upper layer portion UP and the lower layer portion LP may include the anodes 150 having substantially the same active material and stacked structure.

The first cathode tab portion 112a may be formed at one side of the first cathode current collector 112 included in the first cathode 103, and the second cathode tab portion 115a may be formed at one side of the second cathode current collector 115 included in the second cathode 105. The cathode active material layer may not be coated on the cathode tab portions 112a and 115a.

The first cathode tab portions 112a may be aligned to overlap each other in a thickness direction or a height direction in a plan view. The first cathode tab portions 112a may be fused or welded together with a cathode lead 160 at one side of the electrode assembly EA.

The second cathode tab portions 115a may be aligned to overlap each other in the thickness direction or the height direction in the plan view. The second anode tab portions 115a may be fused or welded together with the cathode lead 160 at on one side of the electrode assembly EA.

In example embodiments, the first cathode tab portions 112a and the second cathode tab portions 115a may be horizontally (in a width direction) spaced apart at the same side of the electrode assembly EA in the plan view, as illustrated in FIG. 4. In some embodiments, the first cathode tab portions 112a and the second cathode tab portions 115a may be connected or fused together to the cathode lead 160.

A portion of the cathode lead 160 may be fused together with end portions of the cathode tab portions 112a and 115a within the case 90. For example, the portion of the cathode lead 160 may be sealed with the end portions of the cathode tab portions 112a and 115a within the case 90. A remaining portion of the cathode lead 160 may protrude to an outside of the case 90.

In some embodiments, an anode tab portion 155a may be formed at one side of the anode current collector 155. The anode active material layer 153 may not be coated on the anode tab portion 155a. The anode tab portions 155a protruding from each anode 150 may be aligned to overlap each other in the thickness direction or the height direction when viewed from the other side of the electrode assembly EA in the plan view.

A plurality of the anode tab portions 155a may be welded or fused together with an anode lead 170.

A portion of the anode lead 170 may be fused together with end portions of the anode tab portions 155a within the case 90. For example, the portion of the anode lead 170 may be sealed together with the end portions of the anode tab portions 155a within the case 90. A remaining portion of the anode lead 170 may protrude to an outside of the case 90. An electrolyte may be injected into the case 90 to impregnate the electrode assembly EA. In example embodiments, a non-aqueous electrolyte solution may be used as the electrolyte.

The non-aqueous electrolyte solution may contain a lithium salt and an organic solvent, and the lithium salt may be expressed as, e.g., Li⁺X⁻. The anion X⁻ of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF−, (CF₃)₆P−, CF₃SO₃⁻, CF₃CF₂SO₃⁻, (CF₃SO₂)₂N−, (FSO₂)₂N−, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethylsulfoxide, acetonitrile, dimethoxyethane, diethoxyethane, vinylene carbonate, sulfolane, gamma-butyrolactone, propylene sulfite, tetrahydrofuran, etc. These can be used alone or in a combination of two or more therefrom.

According to the above-described embodiments, the first cathodes 103 having a single cathode active material layer structure/higher-Ni composition with improved high-capacity properties and the second cathodes 105 having a double-layered cathode active material layer structure and improved high-rate properties may be spatially separated into different cathode groups.

The first cathode group and the second cathode group may be included in one electrode assembly EA, so that a lithium secondary battery having improved high-rate properties/high-capacity properties and providing high-temperature stability/capacity retention may be implemented.

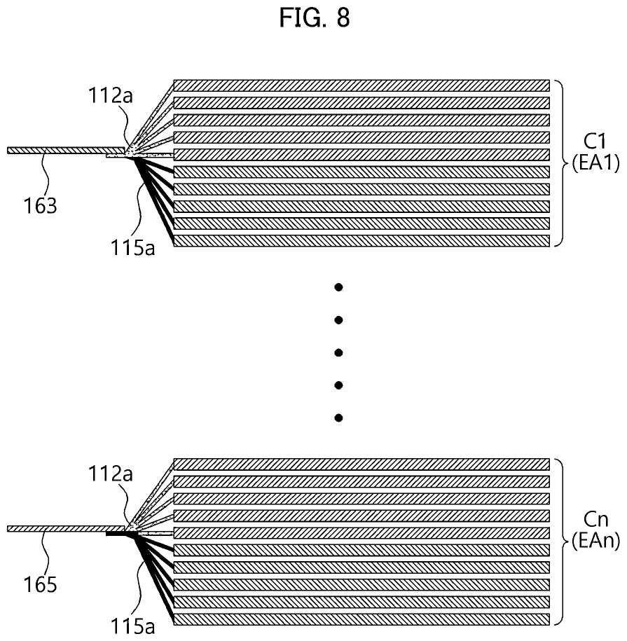

FIG. 7 is a schematic plan view illustrating a secondary battery in accordance with example embodiments. Detailed descriptions of elements and structures substantially the same as or similar to those described with reference to FIGS. 1 to 6 are omitted.

Referring to FIG. 7, the first cathode tab portions 112a and the second cathode tab portions 115a may be connected or fused to a first cathode lead 163 and a second cathode lead 165, respectively.

Accordingly, a first cathode connection structure including the first cathode tab portions 112a and the first cathode lead 163 and a second cathode connection structure including the second cathode tab portions 115a and the second cathode lead 165 may be defined. The first cathode connection structure may serve as an external connection structure of the first cathode group, and the second cathode connection structure may serve as an external connection structure of the second cathode group.

In example embodiments, the first cathode connection structure and the second cathode connection structure may be separated/operated independently from each other. The first cathode connection structure and the second cathode connection structure may be physically and/or electrically separated.

In some embodiments, the anode tab portions may also be divided. As illustrated in FIG. 7, the anode tab portions may be divided first anode tab portions 152a included in the anodes 150 belonging to in the upper layer portion UP of the electrode assembly EA and second anode tab portions 154a included in the anodes 150 belonging to the lower layer portion LP of the electrode assembly EA.

The first anode tab portions 152a may be aligned to overlap in the thickness direction in a plan view, and may be welded or fused together with a first anode lead 173. The second anode tab portions 154a may be aligned to overlap in the thickness direction in the plan view, and may be welded or fused together with a second anode lead 175.

Independent charge/discharge operations of the upper layer portion UP and the lower layer portion LP by the above-described electrode connection structure or electrode lead construction. For example, in an operating environment requiring high capacity/high temperature stability, charging/discharging may be implemented using the upper layer portion UP. In an environment requiring high rate/high power operation, charging/discharging may be implemented using the lower layer portion LP.

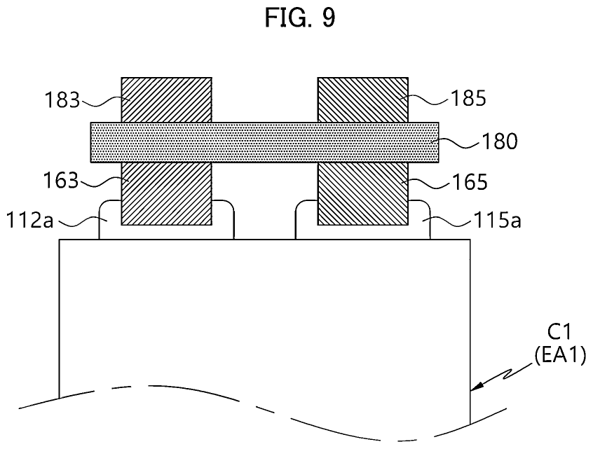

FIGS. 8 and 9 are s schematic cross-sectional view and a schematic plan view, respectively, for describing a battery assembly in accordance with example embodiments. For convenience of descriptions, illustration of the case of each battery cell is omitted in FIGS. 8 and 9.

Referring to FIG. 8, a plurality of battery cells C1 to Cn may be stacked to form a battery assembly. In example embodiments, the battery assembly may be manufactured in the form of a battery module. Each battery cell C1 to Cn may include an electrode assembly EA1 to EAn.

As described above, the cathodes of the electrode assembly EA may be divided into the first cathode group and the second cathode group included in the upper layer portion UP and the lower layer portion LP, respectively, and the first cathode lead 163 and the second cathode lead 165 may be connected to the first cathode group and the second cathode group, respectively.

Referring to FIG. 9, a plurality of the first cathode leads 163 belonging to each battery cell may be aligned to overlap in a thickness direction or a height direction of the battery module in a plan view. A plurality of the second cathode leads 165 belonging to each battery cell may be aligned to overlap in the thickness direction or the height direction of the battery module in a plan view.

The first cathode leads 163 may be connected or fused to each other to be connected to a first cathode module terminal 183. The second cathode leads 165 may be connected or fused to each other to be connected to a second cathode module terminal 185. The first cathode module terminal 183 and the second cathode module terminal 185 may be formed at an outside of the module case.

In an embodiment, a lead fixing structure 180 may be disposed within the module case to merge the first cathode leads 163 and the second cathode leads 165, so that the first cathode module terminal 183 and the second cathode module terminal 185 may be drawn out.

In some embodiments, the anode leads may also be divided as illustrated in FIG. 7 to form a first anode module terminal and a second anode module terminal.

According to the abode-described embodiments, the upper layer portion UP and the lower layer portion LP of the electrode assembly included in each battery cell may be selected to implement independent charge/discharge operations. For example, in an operating environment where high capacity/high temperature stability is required, a module-level charge/discharge may be implemented through the upper layer portion UP.

In an environment where high-rate/high-power operation is required, a module-level charging/discharging may be implemented through the lower layer portion LP.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### Examples and Comparative Examples

Cathodes of Examples and Comparative Examples having stacked structures and active material layer compositions as shown in Table 1 were fabricated.

Specifically, Li[Ni_{0.92}Co_{0.05}Mn_{0.03}]O₂ (represented as Ni92) or Li[Ni_{0.88}Co_{0.09}Mn_{0.03}]O₂ (represented as Ni88) were used as cathode active materials.

When fabricating a first electrode group, a mixture was prepared commonly by mixing 98.08 wt % of the cathode active material, MWCNT as a conductive material, and polyvinylidene fluoride (PVDF) as a binder in a weight ratio of 98.08:0.72:1.2. NMP was added to the mixture to prepare a slurry, and the slurry was uniformly coated on a 12-μm thick aluminum substrate, dried and pressed at a density of 3.6 g/cc to obtain the cathode. About 20 wt % of a total weight of MWCNT was included as a CNT dispersion.

In a second electrode group, while using the same conductive material, the cathode active material and polyvinylidene fluoride (PVDF) as a binder were used in amounts shown in Table 1.

A mixture containing 81.45 wt % of artificial graphite (D50: 17 m) as a graphite-based active material, 15.0 wt % of SiOx (0≤x≤2) as a silicon-based active material, 0.25 wt % of SWCNT as a conductive material, 1.3 wt % of CMC as a thickener and 2.0 wt % of styrene-butadiene rubber (SBR) as a binder (a total solid content 100 wt %) was prepared. Water was added to the mixture to prepare an anode slurry. The anode slurry was uniformly coated on a copper substrate having a thickness of 8 m, and then dried and pressed at a density of 1.6 g/cc to prepare an anode. About 60 wt % of the SWCNT content was includes as a CNT dispersion.

The anode was applied equally to the first and second electrode groups of Examples and Comparative Examples.

The cathodes and the anodes were each notched to a predetermined size and stacked with a separator (polyethylene, thickness: 15 m) interposed therebetween. The cathodes and the anodes were stacked to have the same number of layers in the first and second electrode groups to obtain an electrode assembly.

The electrode assembly was placed in a pouch and sealed at three sides except for an electrolyte injection side. A region around electrode tabs was included in the sealed portion. An electrolyte solution was injected through the electrolyte injection side, and then the electrolyte injection side was also sealed. Thereafter, impregnation was performed for more than 12 hours.

To prepare the electrolyte solution, a 1.1 M LiPF₆ solution was prepared using a mixed solvent of EC/EMC (25/75; volume ratio). The electrolyte solution was prepared by adding 8 wt % of fluoroethylene carbonate (FEC), 0.5 wt % of 1,3-propene sultone (PRS), 0.5 wt % of 1,3-propane sultone (PS) and 0.5 wt % of ethylene sulfate (ESA) to the solution.

Thereafter, a heat press pre-charging was performed for 60 minutes at an average current of 0.5 C. After a stabilization for more than 12 hours, degassing was performed, aging was performed for more than 24 hours, and then chemical charge/discharge was performed (charge conditions: CC-CV, 0.25 C, 4.2 V, 0.05 C, CUT-OFF, discharge conditions: CC, 0.25 C, 2.5 V, CUT-OFF).

Subsequently, a standard charge/discharge was performed (charge conditions: CC-CV, 0.33C, 4.2V, 0.05C, CUT-OFF, discharge conditions: CC, 0.33C, 2.5V, CUT-OFF).

TABLE 1

| | first electrode | | second electrode group | | |
|---|---|---|---|---|---|
| | group | | | cathode | |
| | | cathode | | active | binder |
| | stacked | active | stacked | material | content |
| | structure | material | structure | (wt %) | (wt %) |
| Example 1 | single | Ni92 | upper layer | Ni88 (98.58) | 0.7 |
| | layer | | lower layer | Ni88 (98.08) | 1.2 |
| Example 2 | single | Ni92 | upper layer | Ni88 (98.08) | 1.2 |
| | layer | | lower layer | Ni88 (98.08) | 1.2 |
| Example 3 | single | Ni92 | upper layer | Ni88 (98.08) | 1.2 |
| | layer | | lower layer | Ni88 (98.58) | 0.7 |
| Example 4 | single | Ni88 | upper layer | Ni88 (98.58) | 0.7 |
| | layer | | lower layer | Ni88 (98.08) | 1.2 |
| Comparative | commonly Ni92 single layered structure | | | | |
| Example | | | | | |

### Experimental Example

### (1) Evaluation on Energy Density

The lithium secondary batteries of Examples and Comparative Examples were charged (CC/CV 0.3C 4.2V 0.05C CUT-OFF) and discharged (CC 0.3C 2.5V CUT-OFF) to measure a discharge capacity (Ah) and an energy (Wh).

A volume of each battery was measured at a 4.2V charged state to calculate a volume-energy density.

### (2) Measurement of High-Temperature Capacity Retention

The lithium secondary batteries of the Examples and Comparative Examples were charged at 0.3C under constant current/constant voltage (CC/CV) conditions at a temperature of 45° C. to a voltage corresponding to an SOC98, and then cut off at 0.05C. Thereafter, the batteries were discharged at 0.5C under constant current (CC) conditions to a voltage corresponding to an SOC4, and then a discharge capacity was measured. The above-described charging and discharging as a single cycle was repeated 1000 times. A capacity retention rate was calculated as a percentage of a discharge capacity after the 1000th cycle divided by the discharge capacity of the 1st cycle.

### (3) Evaluation on Rapid Charge Property

The lithium secondary batteries of Examples and Comparative Examples were charged at a temperature of 25° C. with a C-rate of 3.0C/2.75C/2.5C/2.25C/2.0C/1.75C/1.5C/1.25C/1.0C/0.75C/0.5C according to a step charge method to reach a DOD72 within 25 minutes, and then discharged at 0.5C.

The above-described charge and discharge as a single cycle was repeated 300 times. A capacity retention was calculated as a percentage of a discharge capacity after the 300th cycle divided by a discharge capacity after the 1st cycle.

### (4) Evaluation of High-Temperature Storage Property

The lithium secondary batteries of Examples and Comparative Examples were left at 60° C. for 35 weeks, and a time at which venting occurred was measured.

The evaluation results are shown in Table 2 below.

TABLE 2

| | | high- | | |
|---|---|---|---|---|
| | | temperature | | high- |
| | volume- | capacity | rapid charge | temperature |
| | energy | retention | property | storage vent |
| | density | 1000 | 300 | occurring time |
| | (Wh/L) | cycles (%) | cycles (%) | (weeks) |
| Example 1 | 736 | 84.3 | 91.2 | 33 |
| Example 2 | 734 | 83.7 | 88.0 | 32 |
| Example 3 | 731 | 81.2 | 85.6 | 27 |
| Example 4 | 725 | 85.1 | 90.7 | 34 |
| Comparative | 732 | 81.8 | 85.1 | 31 |
| Example | | | | |

Referring to Table 2, in Examples where the first electrode group and the second electrode group had different active material compositions or stacked structures, high-temperature capacity, high-temperature stability, and rapid charging properties were improved and balanced while maintaining the energy density.

What is claimed is:

1. A secondary battery, comprising:
a first cathode group in which first cathodes are stacked adjacent to each other, each of the first cathodes including a first cathode current collector and a first cathode active material layer on the first cathode current collector;
a second cathode group in which second cathodes are stacked adjacent to each other, each of the second cathodes including a second cathode current collector and a second cathode active material layer on the second cathode current collector, the second cathode active material layer having a different active material composition or a different stacked structure from that of the first cathode active material layer; and
anodes facing the first cathode or the second cathode.

2. The secondary battery according to claim 1, wherein the first cathode active material layer includes a first lithium-nickel-based metal oxide, and the second cathode active material layer includes a second lithium-nickel-based metal oxide having a nickel molar ratio smaller than that of the first lithium-nickel-based metal oxide.

3. The secondary battery according to claim 2, wherein a mole fraction of nickel among elements excluding lithium and oxygen in the first lithium-nickel-based metal oxide is 0.9 or more.

4. The secondary battery according to claim 2, wherein a mole fraction of nickel among elements excluding lithium and oxygen in the second lithium-nickel-based metal oxide is 0.8 or more, and less than 0.9.

5. The secondary battery according to claim 2, wherein the second lithium-nickel-based metal oxide includes large-diameter particles and small-diameter particles having different average particle sizes.

6. The secondary battery according to claim 5, wherein the large-diameter particles have a secondary particle shape, and the small-diameter particles have a single particle shape.

7. The secondary battery according to claim 1, wherein the first cathode active material layer has a single-layered structure, and the second cathode active material layer has a multi-layered structure.

8. The secondary battery according to claim 7, wherein the second cathode active material layer includes a lower cathode active material layer and an upper cathode active material layer sequentially stacked from a surface of the second cathode current collector,
each of the upper cathode active material layer and the lower cathode active material layer includes a second lithium-nickel-based metal oxide and a binder, and
the upper cathode active material layer and the lower cathode active material layer have different binder contents.

9. The secondary battery according to claim 8, wherein a binder content based on weight percents contained in the upper cathode active material layer is smaller than a binder content based on weight percents contained in the lower cathode active material layer.

10. The secondary battery according to claim 1, wherein the first cathode current collector includes a first cathode tab portion, and the second cathode current collector includes a second cathode tab portion horizontally spaced apart from the first cathode tab portion.

11. The secondary battery according to claim 10, further comprising a cathode lead fused together with the first cathode tab portion and the second cathode tab portion.

12. The secondary battery according to claim 10, further comprising a first cathode lead fused with the first cathode tab portion, and a second cathode lead fused with the second cathode tab portion and separated from the first cathode lead.

13. The secondary battery according to claim 1, wherein the first cathode group, the second cathode group and the anodes are stacked to define an electrode assembly, and
the first cathode group is arranged at an upper layer portion of the electrode assembly, and the second cathode group is arranged at a lower layer portion of the electrode assembly.

14. A battery assembly comprising a plurality of battery cells each of which includes the secondary battery of claim 1.

15. The battery assembly according to claim 14, further comprising a first cathode module terminal connected to the first cathode current collector included in the first cathode group; and
a second cathode module terminal connected to the second cathode current collector included in the second cathode group,
wherein the first cathode module terminal and the second cathode module terminal are independently separated.
